(19) United States
(12) Patent Application Publication
(10) Pub. No.: US 2022/0004533 A1
(43) Pub. Date: Jan. 6, 2022

(54) TECHNIQUE FOR CONCURRENCY CONTROL

(71) Applicant: Telefonaktiebolaget LM Ericsson (publ), Stockholm (SE)

(72) Inventors: Attila MIHÁLY, Dunakeszi (HU); Maria Cruz BARTOLOME RODRIGO, Madrid (ES)

(21) Appl. No.: 17/296,613

(22) PCT Filed: Dec. 20, 2018
(86) PCT No.: PCT/EP2018/086208

§ 371 Date: May 25, 2021

(30) Foreign Application Priority Data
Nov. 27, 2018 (EP) 18382859.9

(51) Int. Cl. G06F 16/23; G06F 16/25

(52) U.S. Cl. CPC G06F 16/2343; G06F 16/2365; G06F 16/252

(57) ABSTRACT

A technique for concurrency control of transactions in a system comprising a plurality of application instances accessing a database system is provided. A method implementation of the technique is performed by the database system and comprises receiving, from a first application instance of the plurality of application instances, a transaction start request indicating a start of a transaction to lock data stored in the database system against access requests not belonging to the transaction while the transaction is ongoing, receiving, from a second application instance of the plurality of application instances, an access request to at least a portion of the data while the transaction is ongoing, and controlling acceptance of the access request based on checking whether the access request belongs to the transaction.

### TECHNICAL FIELD

The present disclosure generally relates to the field of concurrent computing. In particular, a technique for concurrency control of transactions in a system comprising a plurality of application instances accessing a database system is presented. The technique may be embodied in methods, computer programs, apparatuses and systems.

### BACKGROUND

In next generation (5G) mobile communication networks, there is a general trend that network architectures are built around the Service Based Architecture (SBA) paradigm, which means that there will be network domains, such as the Core Network (CN), in which functional components are defined as “services”, i.e., self-contained functionalities, that can be modified in an isolated manner (without affecting others). Services will likely be built in a stateless way, i.e., the application logic of the services and the data context will be separated, which means that the services will typically store their context externally in proprietary databases. While such architectures will enable a variety of cloud infrastructure features, like auto-scaling or auto-healing, the stateless nature of the services also implies that multiple instances of the same or different services may need to simultaneously access the same data, potentially resulting in race conditions. If suitable concurrency control among these accesses is not provided, inconsistent states across the system may be the consequence, e.g., due to overwriting of data that has been updated by other instances. An example is when certain session management actions (e.g., session establishment or session modification) that require changes to the session context of a User Equipment (UE) are ongoing and when a handover occurs at the same time for the same UE impacting the same user path.

An exemplary case in which race condition handling is necessary is shown in FIG. 1, where instances of different services access attributes stored in a UE session context database. In step 1 of this procedure, an instance of service A reads an attribute Y from the database, which is successfully returned. The instance of service A then checks the value of attribute Y and, if the attribute has a certain value (Y=A), a procedure 1 is executed, which may involve other services and multiple database accesses (not only read, but also write). In step 2, an instance of another service B may likewise read an attribute X and start a procedure 2 when attribute X has a certain value (X=M), so that simultaneous procedures are then ongoing. Steps 3, 4a and 5 indicated in the figure are part of procedure 1, wherein attribute X is modified in step 4a. For generality, it is shown that another service instance (i.e., an instance of service C) modifies attribute X, but this could also be an instance of service A, for example. Further, in step 4b (which may be executed simultaneously to procedure 1), an instance of service D modifies attribute Y to a value different from A. Since value A was necessary to trigger procedure 1 (Y=A), as described above, procedure 1 may thus be invalidated and rollback functions may need to be executed. Rollbacks may not always be possible, however, especially when procedures may trigger other procedures, so that changes to be rolled back are chained.

Various techniques for concurrency control dealing with such situations are generally known. One such technique is strict locking (also known as explicit locking), where explicit locks are employed to handle race conditions. An example of such technique is shown in FIG. 2, in which an instance X of a service A is granted exclusive access (read, write or both) to a record R stored in a UE context database C, wherein other service instances, such as an instance Y (which may be an instance of the same service A or an instance of another service B requiring access to the same record R), will be blocked when attempting to access the record R until the lock is released by the instance holding it, i.e., instance X.

Another technique is optimistic locking (also known as opportunistic concurrency control (OCC)) which is generally based on the assumption that multiple transactions can frequently complete without interfering each other. Using OCC, while running, transactions may use data resources without acquiring locks on those resources. Before committing, each transaction verifies that no other transaction has modified the data it has read, wherein it may be required that any OCC write transaction is preceded by a read operation for the same set of data. As shown in the example of FIG. 3, in one variant, the database may generate and send a token (which can be a timestamp of the latest update of record R, for example) to the instance that reads the record R and each committing transaction is then required to send this token in any update request. If there is a subsequent write to the record R, the token is updated (invalidated) and, therefore, all further attempts to update the record R using an invalid token reveals conflicting modifications and will consequently fail. In these cases, the committing transaction rolls back and may be restarted.

Although such techniques for concurrency control have proven their suitability in certain scenarios, they may suffer from their drawbacks in other scenarios. Strict locking, for example, may be a long and expensive operation, especially if it is used for complex transactions. In mobile communication networks, such as 5G networks, a procedure that involves multiple interactions between different entities or services in the CN typically requires multiple database accesses (both reads and writes) from different entities. Such transactions are successful if all database updates involved succeed. If strict locking is used, it is necessary that the updating entity sends an exclusive lock request for the related attributes/records at the beginning of the transaction and keeps the lock as long as the last database update is completed. This means, however, that no other entity has access to that data until the update is terminated, which may take a long time in case of complex procedures. This also includes other instances of the same service that may be required to participate in the same transaction, which cannot participate because of the exclusive lock. As a resolution, complicated mechanisms may be required to redirect messages within the same transaction to the entity that locks the database.

OCC, on the other hand, is a faster method and may be suitable for use in mobile communication networks, in which data contention among different transactions is generally low. However, OCC may not be suitable in case of complex transactions with multiple database updates either. For example, if a database update is invalid during the transaction, all previous and successful database transactions would have to be rolled back. This rollback can be complex to implement, because, on the one hand, inferring what should be rolled back by the updating service instance may be cumbersome (several instances may have been involved and what should be rolled back may generally depend on the functional logic of the instances) and, on the other hand, even some decisions may have already been made based on previous interactions that are optimistically considered to be successful. Another problem related to the rollback of multi-step transactions is that OCC may result in starving concurrent transactions. This may happen when an update is invalidated in one transaction, which initiates a rollback and restart. During this rollback event (which may also involve database updates for previously successful transactions), a step of another transaction that is still ongoing may also get an invalidation for its updates and start to roll back as well.

An additional problem related to database transactions, that applies to both strict locking and OCC, may occur when whole attribute ranges are read. If the value of any of these attributes changes, race condition handling affecting the ongoing transactions is typically triggered even if the changed values do not modify the outcome of other procedures that run in parallel. In such cases, it may be beneficial if race condition handling is not triggered.

### SUMMARY

Accordingly, there is a need for a technique for concurrency control that avoids one or more of the problems discussed above, or other problems.

According to a first aspect, a method for concurrency control of transactions in a system comprising a plurality of application instances accessing a database system is provided. The method is performed by the database system and comprises receiving, from a first application instance of the plurality of application instances, a transaction start request indicating a start of a transaction to lock data stored in the database system against access requests not belonging to the transaction while the transaction is ongoing, receiving, from a second application instance of the plurality of application instances, an access request to at least a portion of the data while the transaction is ongoing, and controlling acceptance of the access request based on checking whether the access request belongs to the transaction.

Controlling acceptance of the access request may include one of accepting the access request when the access request belongs to the transaction and rejecting the access request when the access request does not belong to the transaction. The first application instance may be different from the second application instance. The first application instance and the second application instance may be instances of different types of applications. The transaction start request may include a first transaction identifier uniquely identifying the transaction and the access request may include a second transaction identifier indicating a transaction to which the access request belongs, wherein checking whether the access request belongs to the transaction may include comparing the first transaction identifier and the second transaction identifier. Locking the data may include marking the data by the first transaction identifier, wherein, prior to comparing the first transaction identifier and the second transaction identifier, the first transaction identifier may be retrieved based on the marking of the at least a portion of the data to be accessed by the access request.

The access request may be a write request and read requests to the data from the plurality of application instances may be accepted independently of whether the read requests belong to the transaction. The transaction start request may include an indication of the data to be locked while the transaction is ongoing. Also, the data to be locked may comprise data that is subject to read requests performed as part of the ongoing transaction. The transaction start request may correspond to an initial read request performed as part of the transaction. The data to be locked may comprise one or more attributes of a record of the database system. The one or more attributes of the record may correspond to a subset of attributes among a plurality of attributes of the record, wherein the subset of attributes includes attributes which are identified as attributes which may be subject to a race condition in the ongoing transaction. The method may further comprise receiving a transaction end request indicating an end of the transaction. The transaction end request may be received from a third application instance of the plurality of application instances, the third application instance being different from the first application instance. The system may be a mobile communication system and the database system may be a central database system employed in the mobile communication system.

According to a second aspect, a method for concurrency control of transactions in a system comprising a plurality of application instances accessing a database system is provided. The method is performed by a first application instance of the plurality of application instances and comprises triggering sending, to the database system, a transaction start request indicating a start of a transaction to cause the database system to lock data stored in the database system against access requests not belonging to the transaction while the transaction is ongoing.

The method according to the second aspect defines a method from a first application instance's perspective which may be complementary to the method according to the first aspect. As such, those aspects described with regard to the method of the first aspect which are applicable to the method of the second aspect may be comprised by the method of the second aspect as well, and vice versa.

As in the method of the first aspect, the transaction start request may include a transaction identifier uniquely identifying the transaction. The transaction start request may include an indication of the data to be locked while the transaction is ongoing. Also, the transaction start request may correspond to an initial read request performed as part of the transaction. The data to be locked may comprise one or more attributes of a record of the database system. The one or more attributes of the record may correspond to a subset of attributes among a plurality of attributes of the record, wherein the subset of attributes includes attributes which are identified as attributes which may be subject to a race condition in the ongoing transaction. The method may further comprise triggering sending, to a second application instance, a message including the transaction identifier indicating to the second application instance that the message belongs to the ongoing transaction. The method may further comprise triggering sending, to the database system, a transaction end request indicating an end of the transaction. The system may be a mobile communication system and the database system may be a central database system employed in the mobile communication system.

According to a third aspect, a method for concurrency control of transactions in a system comprising a plurality of application instances accessing a database system is provided. The method is performed by a second application instance of the plurality of application instances and comprises triggering sending, to the database system, an access request to at least a portion of data stored in the database system, the data being locked by the database system against access requests not belonging to an ongoing transaction.

The method according to the third aspect defines a method from a second application instance's perspective which may be complementary to either the method according to the first aspect or the method according to the second aspect. As such, those aspects described with regard to the methods of the first and second aspects which are applicable to the method of the third aspect may be comprised by the method of the third aspect as well, and vice versa.

In accordance with the method of the first aspect, the method may comprise one of receiving, from the database system, an acceptance of the access request when the access request belongs to the ongoing transaction and receiving, from the database system, a rejection of the access request when the access request does not belong to the ongoing transaction. The method may further comprise receiving, from a first application instance, a message including a transaction identifier indicating that the message belongs to the ongoing transaction. The access request may include a transaction identifier indicating a transaction to which the access request belongs. The method may further comprise triggering sending, to the database system, a transaction end request indicating an end of the transaction. The system may be a mobile communication system and the database system may be a central database system employed in the mobile communication system.

According to a fourth aspect, a computer program product is provided. The computer program product comprises program code portions for performing the method of at least one of the first, the second and the third aspect when the computer program product is executed on one or more computing devices (e.g., a processor or a distributed set of processors). The computer program product may be stored on a computer readable recording medium, such as a semiconductor memory, DVD, CD-ROM, and so on.

According to a fifth aspect, a computing unit configured to execute a database system for concurrency control of transactions in a system comprising a plurality of application instances accessing the database system provided. The computing unit comprises at least one processor and at least one memory, the at least one memory containing instructions executable by the at least one processor such that the database system is operable to perform any of the method steps presented herein with respect to the first aspect.

According to a sixth aspect, a computing unit configured to execute a first application instance for concurrency control of transactions in a system comprising a plurality of application instances accessing a database system is provided. The computing unit comprises at least one processor and at least one memory, the at least one memory containing instructions executable by the at least one processor such that the first application instance is operable to perform any of the method steps presented herein with respect to the second aspect.

According to a seventh aspect, a computing unit configured to execute a second application instance for concurrency control of transactions in a system comprising a plurality of application instances accessing a database system is provided. The computing unit comprises at least one processor and at least one memory, the at least one memory containing instructions executable by the at least one processor such that the second application instance is operable to perform any of the method steps presented herein with respect to the third aspect.

According to an eighth aspect, there is provided a system comprising a computing unit of the fifth aspect, a computing unit of the sixth aspect and a computing unit of the seventh aspect.

### BRIEF DESCRIPTION OF THE DRAWINGS

Implementations of the technique presented herein are described herein below with reference to the accompanying drawings, in which:

FIG. 1 illustrates a signaling diagram of an exemplary procedure that requires concurrency control;

FIG. 2 illustrates a signaling diagram exemplifying the use of strict locking;

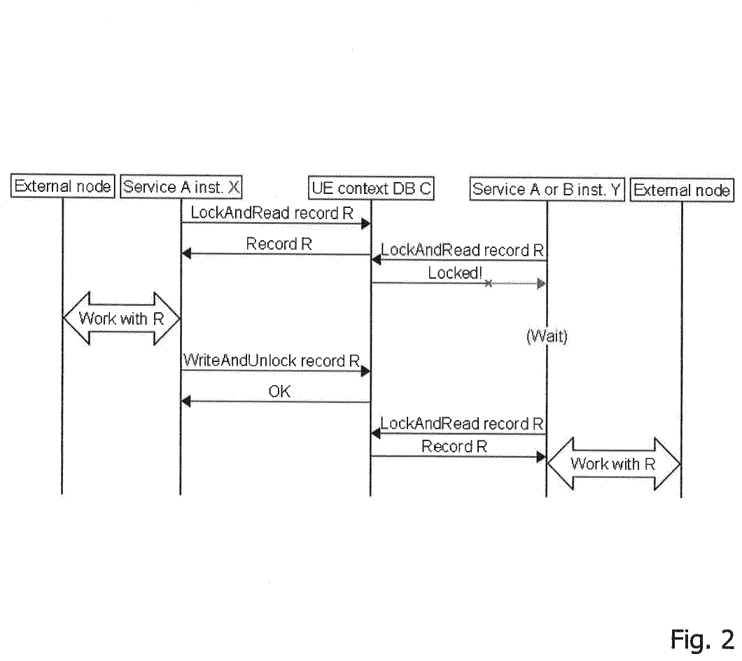

FIG. 3 illustrates a signaling diagram exemplifying the use of OCC;

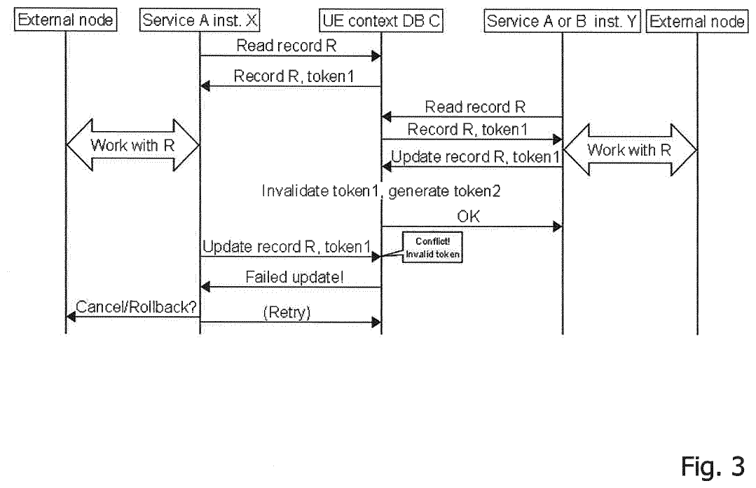

FIGS. 4a to 4c illustrate exemplary compositions of a computing unit configured to execute a database system, a computing unit configured to execute a first application instance, and a computing unit configured to execute a second application instance according to the present disclosure;

FIG. 5 illustrates a method which may be performed by the database system according to the present disclosure;

FIG. 6 illustrates a method which may be performed by the first application instance according to the present disclosure;

FIG. 7 illustrates a method which may be performed by the second application instance according to the present disclosure;

FIG. 8 illustrates a signaling diagram of an exemplary interaction between the database system, the first application instance and the second application instance according to the present disclosure;

FIG. 9 illustrates a flowchart of an exemplary race condition checking method according to the present disclosure; and

FIG. 10 illustrates a signaling diagram of an exemplary interaction between the database system and several service instances which builds upon the example of FIG. 1 and in which the technique of the present disclosure is employed.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

Those skilled in the art will further appreciate that the steps, services and functions explained herein below may be implemented using individual hardware circuitry, using software functioning in conjunction with a programmed micro-processor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

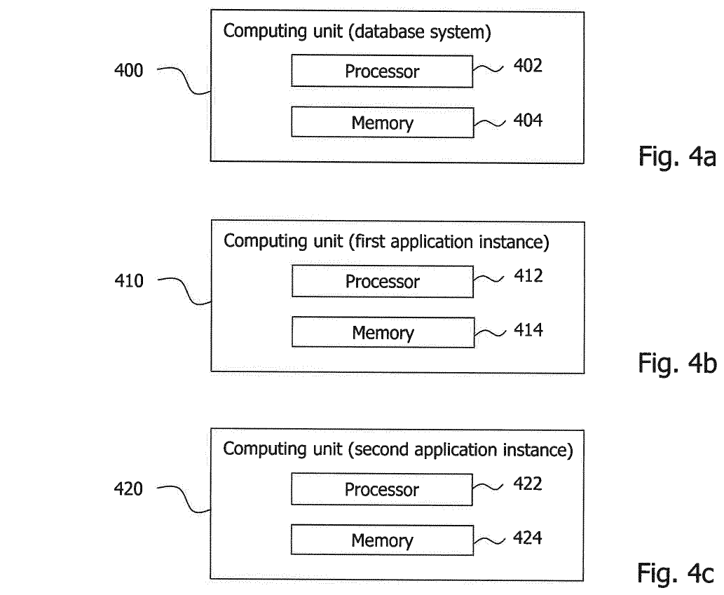

FIG. 4a schematically illustrates an exemplary composition of a computing unit 400 configured to execute a database system for concurrency control of transactions in a system comprising a plurality of application instances accessing the database system. The computing unit 400 comprises at least one processor 402 and at least one memory 404, wherein the at least one memory 404 contains instructions executable by the at least one processor 402 such that the database system is operable to carry out the method steps described herein below with reference to the database system.

FIG. 4b schematically illustrates an exemplary composition of a computing unit 410 configured to execute a first application instance for concurrency control of transactions in a system comprising a plurality of application instances accessing a database system. The computing unit 410 comprises at least one processor 412 and at least one memory 414, wherein the at least one memory 414 contains instructions executable by the at least one processor 412 such that the first application instance is operable to carry out the method steps described herein below with reference to the first application instance.

FIG. 4c schematically illustrates an exemplary composition of a computing unit 420 configured to execute a second application instance for concurrency control of transactions in a system comprising a plurality of application instances accessing a database system. The computing unit 420 comprises at least one processor 422 and at least one memory 424, wherein the at least one memory 424 contains instructions executable by the at least one processor 422 such that the second application instance is operable to carry out the method steps described herein below with reference to the second application instance.

It will be understood that each of the computing unit 400, the computing unit 410 and the computing unit 420 may be implemented on a physical computing unit or a virtualized computing unit, such as a virtual machine, for example. It will further be appreciated that each of the computing unit 400, the computing unit 410 and the computing unit 420 may not necessarily be implemented on a standalone computing unit, but may be implemented as components—realized in software and/or hardware—residing on multiple distributed computing units as well, such as in a cloud computing environment, for example.

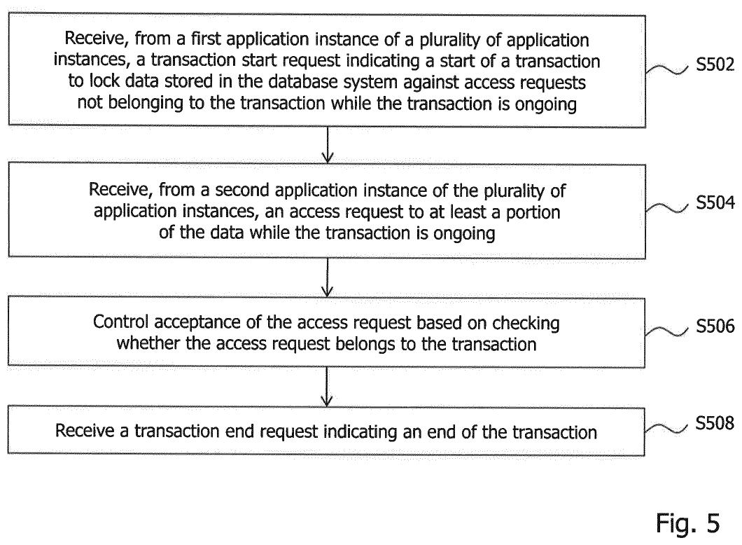

FIG. 5 illustrates a method which may be performed by the database system executed on the computing unit 400 according to the present disclosure. The method is dedicated to performing concurrency control of transactions in a system comprising a plurality of application instances accessing the database system. In step S502, the database system may receive, from a first application instance of the plurality of application instances (e.g., the first application instance executed on computing unit 410), a transaction start request indicating a start of a transaction to lock data stored in the database system against access requests not belonging to the transaction while the transaction is ongoing. In step S504, the database system may receive, from a second application instance of the plurality of application instances (e.g., the second application instance executed on computing unit 420), an access request to at least a portion of the data while the transaction is ongoing. In step S506, the database system may control acceptance of the access request based on checking whether the access request belongs to the transaction. In step S508, the database system may receive a transaction end request indicating an end of the transaction.

The plurality of application instances accessing the database system may comprise instances of one or more applications. The plurality of application instances may access the database system concurrently so that transactions may be used to handle race conditions occurring when the database system is accessed. The database system may correspond to a database management system (DBMS), for example, but is not limited thereto, and it will be understood that the database system may generally correspond to any other application logic that is executed on a layer on top of a database. Each transaction may comprise one or more access requests (e.g., read and/or write requests) to the database system, wherein each of the one or more access requests may be performed by one of the plurality of application instances. The access requests of a transaction may not necessarily originate from the same application instance and, rather, the one or more access requests may comprise access requests from different application instances among the plurality of application instances (possibly even from instances of different types of applications). A transaction may be considered successful if all of the one or more access requests are successful themselves, e.g., without occurrence of side effects caused by race conditions.

A transaction may be initiated, in accordance with step S502, by a transaction start request indicating the start of the transaction and causing the database system to lock data stored in the database system against access requests not belonging to the transaction while the transaction is ongoing. Rather than locking the data exclusively by the first application instance from which the transaction start request is received, the data may thus be locked based on the transaction itself, so that acceptance of an access request to at least a portion of the data (which is received in accordance with step S504) may be controlled based on checking, in accordance with step S506, whether the access request belongs to the ongoing transaction or not. In this way, the locking and granting of access to the data may be managed by the database system itself, so that the lock may be exclusive to the transaction but not exclusive to the application instance that requested to lock (as it is the case in the strict locking technique described above, for example).

Based on the result of checking whether the access request belongs to the transaction or not, the access request may be accepted or rejected. Controlling acceptance of the access request may thus include one of accepting the access request when the access request belongs to the transaction and rejecting the access request when the access request does not belong to the transaction. As the lock of the data may not be exclusive to a particular application instance, the first application instance from which the transaction start request is received may be different from the second application instance from which the access request is received. The first application instance and the second application instance may even be instances of different types of applications.

In order to identify whether the access request belongs to the ongoing transaction, the transaction may be assigned a transaction identifier and the access request may include a transaction identifier that may be checked on a match with the transaction identifier of the ongoing transaction. In one variant, the transaction start request may thus include a first transaction identifier uniquely identifying the transaction and the access request may include a second transaction identifier indicating a transaction to which the access request belongs, wherein checking whether the access request belongs to the transaction may include comparing the first transaction identifier and the second transaction identifier. Upon a match of the first and second transaction identifiers, the access request may be accepted and otherwise rejected.

The database system may store the first transaction identifier upon receipt of the transaction start request for later comparison with transaction identifiers included in subsequent access requests. In one implementation, the first transaction identifier may be stored in association with the data to be locked so that, when at least a portion of the data is attempted to be accessed by an access request, it may be checked whether the transaction identifier included in the access request matches the first transaction identifier is stored in association with the data. In other words, locking the data may include marking the data by the first transaction identifier, wherein, prior to comparing the first transaction identifier and the second transaction identifier, the first transaction identifier may be retrieved based on the marking of the at least a portion of the data to be accessed by the access request.

The access request may correspond to a read request or a write request. Since only write requests may generally be capable of causing inconsistencies in the data upon the occurrence of race conditions, the lock may apply to write requests only. The access request received from the second application instance may thus be a write request, wherein read requests to the data from the plurality of application instances may be accepted independently of whether the read requests belong to the transaction.

The data to be locked may be specified in different ways. In one variant, the data to be locked may be specified upon request of the first application instance when sending the transaction start request, e.g., the transaction start request may include an indication of the data to be locked while the transaction is ongoing. In another variant, which may be alternative or additional to the previous variant, the data to be locked may be marked upon every database access that is performed as part of the ongoing transaction, e.g., the data to be locked may comprise data that is subject to read requests performed as part of the ongoing transaction. In one particular such variant, the first read request may be given by the transaction start request itself, i.e., the transaction start request may correspond to an initial read request performed as part of the transaction. The data to be locked may comprise one or more records and, in one particular variant, the data to be locked may comprise one or more attributes of a record of the database system. In such a variant, only specific attributes to be accessed by the access request which may be subject to a potential race condition may be marked to be locked. The one or more attributes of the record may thus correspond to a subset of attributes among a plurality of attributes of the record, wherein the subset of attributes includes attributes which are identified as attributes which may be subject to a race condition in the ongoing transaction. In this way, control may be limited to a minimum set of attributes, which may be expedient since, in a database access, many attributes may generally be updated at once, but only a few attributes may need to be controlled for potential race conditions with other transactions. The attributes which may be subject to a race condition in the ongoing transaction may be identified from the application logic of the first application instance which sent the transaction start request, for example.

When the lock of the data is to be released, the database system may receive, in accordance with step S508, a transaction end request indicating an end of the transaction. Upon receipt of the transaction end request, the database system may release the lock from the data. The transaction end request may be received from one of the first application instance which sent the transaction start request and the second application instance which sent the access request. As the lock of the data may not be exclusive to a particular application instance, as described above, the transaction end request may also be received from a third application instance of the plurality of application instances, wherein the third application instance may be different from the first application instance (as well as from the second application instance).

The system in which the plurality of application instances and the database system are comprised may be a mobile communication system and the database system may be a central database system employed in the mobile communication system. The mobile communication system may comprise a cellular network, such as a 5G network, for example, and the database system may be a database system which stores session context information for UEs registered with the mobile communication system, for example. An application instance may correspond to an instance of a service in accordance with the SBA paradigm, e.g., provided in a network domain of the mobile communication system.

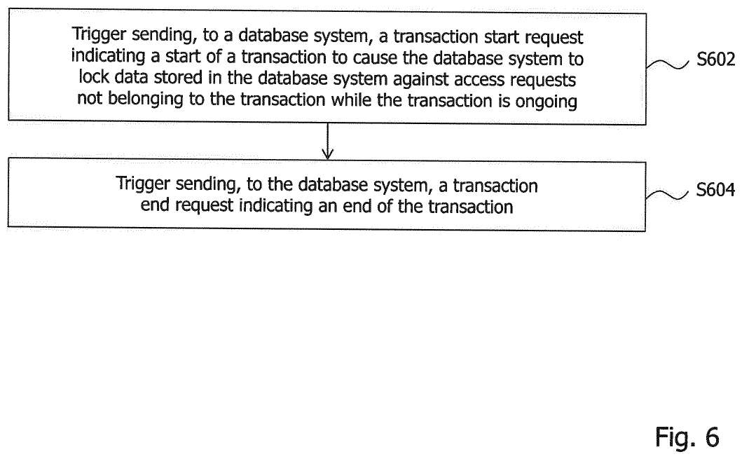

FIG. 6 illustrates a method which may be performed by the first application instance executed on the computing unit 410 according to the present disclosure. The method is dedicated to performing concurrency control of transactions in a system comprising a plurality of application instances accessing a database system (e.g., the database system executed on computing unit 400). The operation of the first application instance may be complementary to the operation of the database system described above in relation to FIG. 5 and, as such, aspects described above with regard to the operation of the first application instance may be applicable to the operation of the first application instance executed on the computing unit 410 described in the following as well. Unnecessary repetitions are thus omitted in the following.

In step S602, the first application instance may trigger sending, to the database system, a transaction start request indicating a start of a transaction to cause the database system to lock data stored in the database system against access requests not belonging to the transaction while the transaction is ongoing. In step S604, the first application instance may trigger sending, to the database system, a transaction end request indicating an end of the transaction.

As described above in relation to FIG. 5, the transaction start request may include a transaction identifier uniquely identifying the transaction. The transaction start request may include an indication of the data to be locked while the transaction is ongoing. Also, the transaction start request may correspond to an initial read request performed as part of the transaction. The data to be locked may comprise one or more attributes of a record of the database system. The one or more attributes of the record may correspond to a subset of attributes among a plurality of attributes of the record, wherein the subset of attributes includes attributes which are identified as attributes which may be subject to a race condition in the ongoing transaction. The first application instance may further trigger sending, to a second application instance, a message including the transaction identifier indicating to the second application instance that the message belongs to the ongoing transaction. By including the transaction identifier in the message sent to the second application instance, the second application instance may know that the message belongs to the ongoing transaction and the second application instance may thus, in turn, include the transaction identifier in further messages sent by itself, thereby conveying the transactional information to further application instances, resulting in a message flow subject to the same transaction. The system may be a mobile communication system and the database system may be a central database system employed in the mobile communication system.

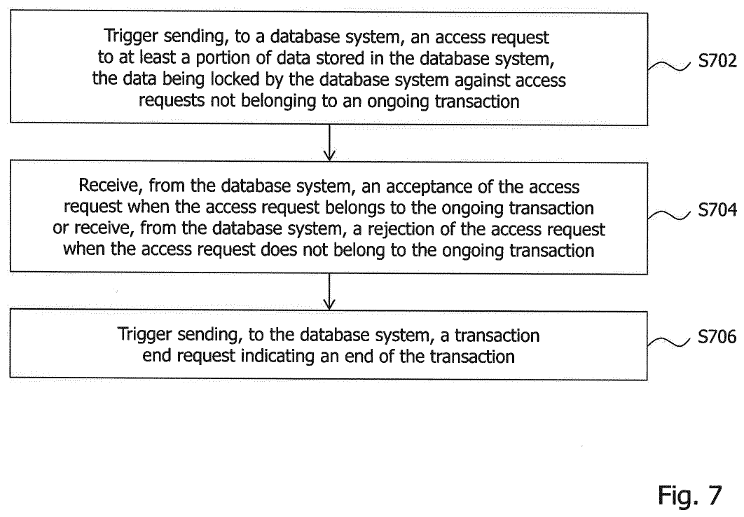

FIG. 7 illustrates a method which may be performed by the second application instance executed on the computing unit 420 according to the present disclosure. The method is dedicated to performing concurrency control of transactions in a system comprising a plurality of application instances accessing a database system (e.g., the database system execute on computing unit 400). The operation of the second application instance may be complementary to the operation of the database system described above in relation to FIG. 5 and/or the operation of the first application instance described above in relation to FIG. 6 and, as such, aspects described above with regard to the operation of the second application instance may be applicable to the operation of the second application instance described in the following as well. Unnecessary repetitions are thus omitted in the following.

In step S702, the second application instance may trigger sending, to the database system, an access request to at least a portion of data stored in the database system, the data being locked by the database system against access requests not belonging to an ongoing transaction. In step S704, the second application instance may either receive, from the database system, an acceptance of the access request when the access request belongs to the ongoing transaction or receive, from the database system, a rejection of the access request when the access request does not belong to the ongoing transaction. In step S706, the second application instance may trigger sending, to the database system, a transaction end request indicating an end of the transaction.

As described above in relation to FIGS. 5 and 6, the access request may include a transaction identifier indicating a transaction to which the access request belongs. The second application instance may further receive, from a first application instance, a message including the transaction identifier indicating that the message belongs to the ongoing transaction. The transaction identifier included in the access request may correspond to the transaction identifier received in the message from the first application instance, so that the transaction identifier may correspond to transactional information that is sent along a message flow subject to the ongoing transaction. When the transaction identifier included in the access request corresponds to a different transaction identifier, the access request may belong to a transaction different from the ongoing transaction. The system may be a mobile communication system and the database system may be a central database system employed in the mobile communication system.

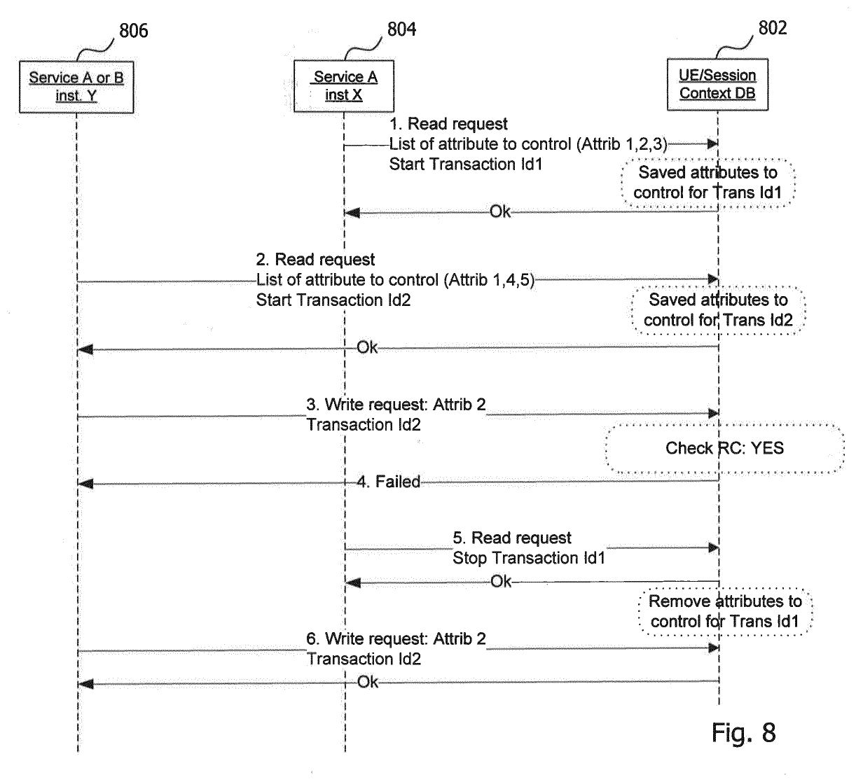

FIG. 8 illustrates a signaling diagram of an exemplary interaction between the database system, the first application instance and the second application instance according to the present disclosure. In the example of FIG. 8, the database system is denoted by reference numeral 802 and corresponds to a UE session context database of a mobile communication system, the first application instance is denoted by reference numeral 804 and corresponds to an instance X of a service A provided in the mobile communication system, and the second application instance is denoted by reference numeral 806 and corresponds to an instance Y of service A (or another service B) provided in the mobile communication system.

In step 1 of the procedure, the first application instance 804 may send a transaction start request to the database system 802 including a first transaction identifier Id1 and an indication of the data to be locked which, in the shown example, is a list of attributes (attributes 1, 2, 3). As indicated in the figure, the transaction start request may come in the form of a read request, e.g., to read the values of the requested attributes. Upon receipt of the transaction start request, the database system 802 may save the requested attributes in association with the first transaction identifier Id1 and send back an acknowledgment as well as return the requested attribute values to the first application instance 804. It is to be noted that the lock for the requested attributes may not be exclusive to the first application instance 804 but exclusive to the first transaction identified by the identifier Id1. If the attribute list was not specified in the transaction start request, the data to be locked may comprise data that is subject to subsequent read requests performed as part of the first transaction with identifier Id1.

In step 2, the second application instance 806 may similarly send a transaction start request to the database system 802 including a second transaction identifier Id2 and an indication of data to be locked which, in the shown example, is a list of attributes 1, 4 and 5. The transaction start request may again come in the form of a read request, e.g., to read the values of the requested attributes 1, 4 and 5. Upon receipt of the transaction start request, the database system 802 may save the requested attributes in association with the second transaction identifier Id2 and send back an acknowledgment as well as return the requested attribute values to the second application instance 806. It is to be noted that the list of attributes 1, 2 and 3 subject to the first transaction with identifier Id1 and the list of attributes 1, 4 and 5 subject to the second transaction with identifier Id2 overlap, but this does not trigger any specific actions at this stage.

In step 3, the second application instance 806 may send a write request to the database system 802 for a particular attribute, i.e., attribute 2 in the shown example, wherein the write request includes a second transaction identifier Id2 indicating that the write request belongs to the second transaction with identifier Id2. The database system 802 may then perform a race condition (RC) check by comparing the first transaction identifier Id1 and the second transaction identifier Id2 and, due to a mismatch of the identifiers, the database system 802 may detect that there is an attempt to write an attribute (2) which is locked by another transaction (i.e., the first transaction with identifier Id1). The database system 802 may thus reject the write request by sending a failure indication towards the second application instance 806 in step 4.

After all database updates within the first transaction with identifier Id1 are completed, the first application instance 804 may send a transaction end request to the database system 802 indicating an end of the first transaction with identifier Id1 in step 5. In the shown example, the transaction end request may again come in the form of a read request. Upon receipt of the transaction end request, the database system 802 may remove the list of attributes for the first transaction with identifier Id1 and stop the transaction accordingly. As there are no overlapping locked attributes for the second transaction with identifier Id2 anymore, any further write requests performed as part of the second transaction with identifier Id2 will now succeed, as exemplarily indicated in step 6 of the figure. Such requests may be triggered by a timer started at the second application instance 806 after the last unsuccessful request attempt (e.g., the attempt in step 3) or by a direct callback from the database system 802 after step 5, for example.

In the example, it will be understood that, between steps 1 and 5, further interactions between the first and second application instances 804 and 806 as well as possibly other application instances may take place (not shown in FIG. 8 for simplicity). Also, it will be understood that the transaction end request does not necessarily have to be sent from the first application instance 804 but may also be sent from another application instance (possibly belonging to a service different from services A and B) that is involved in the first transaction with identifier Id1.

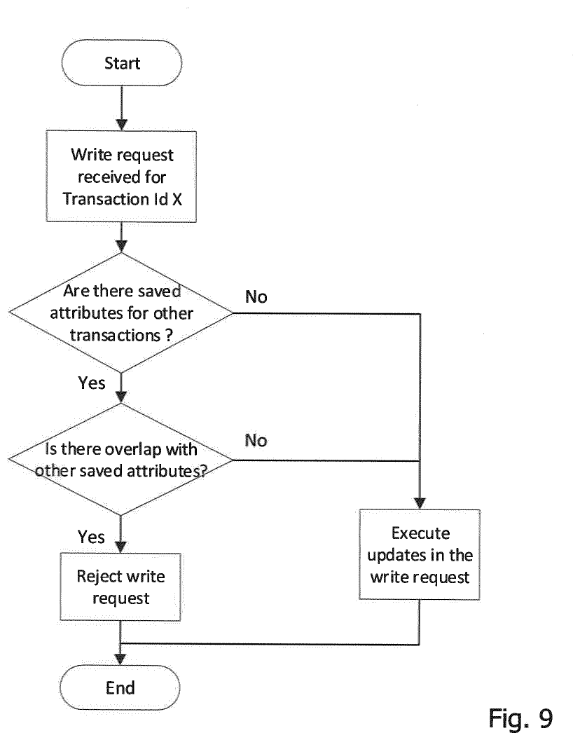

FIG. 9 illustrates a flowchart of an exemplary race condition checking method which may be performed by the database system 802. Essentially, the method may comprise, for an access request (which in the shown example is a write request) received for a transaction with identifier IdX, comparing the transaction identifier IdX with the transaction identifier stored in association with the data to be accessed. More specifically, if the data to be accessed corresponds to one or more attributes, it may be checked whether attributes are stored for other transactions and, if so, it may be checked whether there is an overlap with these attributes. If there is an overlap, the access request may be rejected. Otherwise, if there are no attributes for transactions or if there is no overlap between attributes, the access request may be accepted. As an exemplary implementation of these two decision processes, it may be conceivable that, upon receipt of a list of attributes to be controlled, the database system 802 applies a marking for the requested attributes together with the corresponding transaction identifier. When an access request then arrives, the database system 802 may check these markings and, if there is a marking with a different transaction identifier, the access request may be rejected.

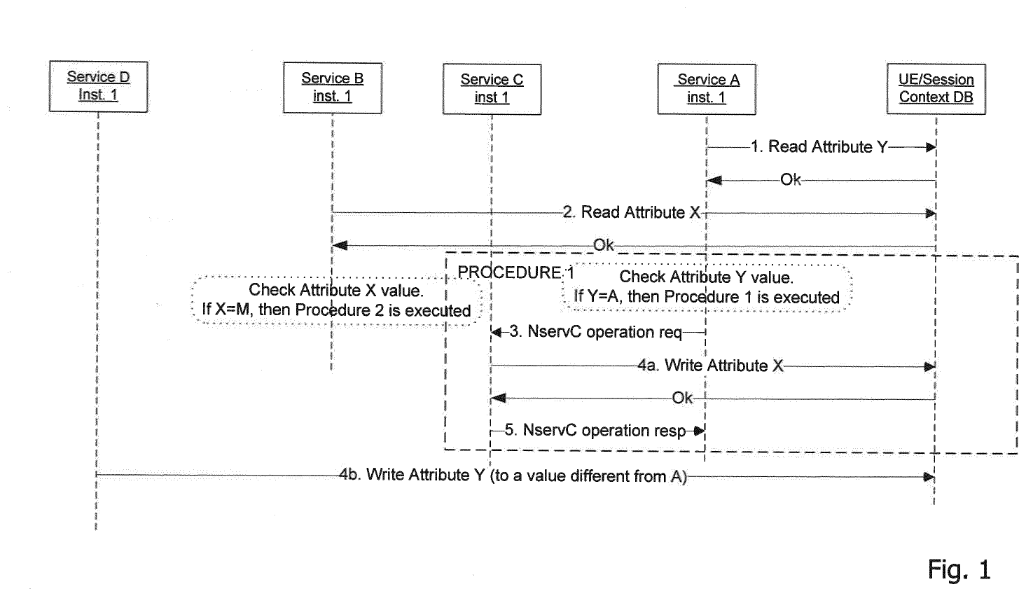

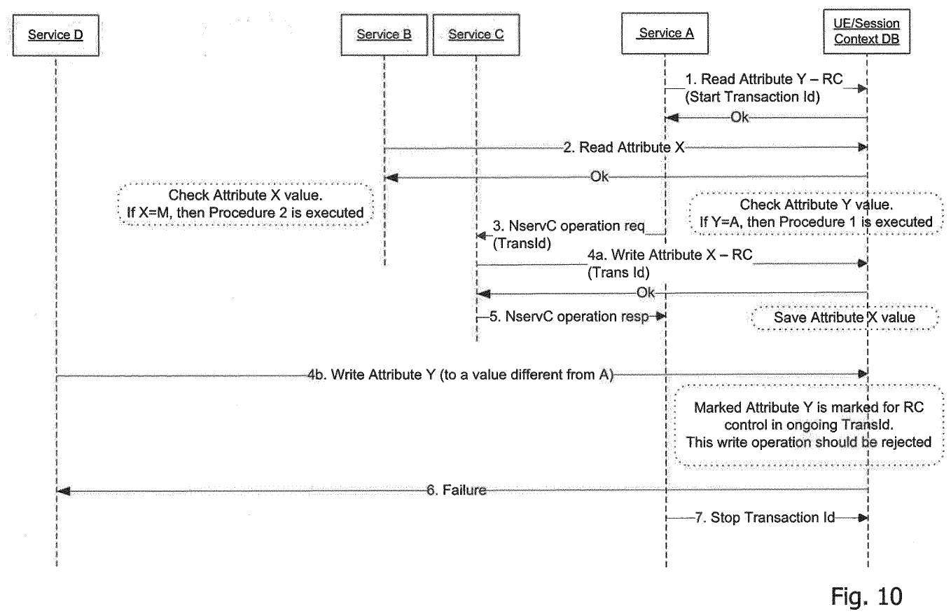

FIG. 10 illustrates a signaling diagram of an exemplary interaction between a database system and several service instances which builds upon the example described above in relation to FIG. 1 and which provides concurrency control therefor. As such, the signaling diagram of FIG. 10 essentially equals the signaling diagram of FIG. 1 and, in the following, only the differences will thus be described.

In step 1 of the procedure, the instance of service A starts a new transaction and marks the read request as a transaction start request including a transaction Id. The instance may also mark the data which may be subject to a race condition, i.e., data that, if modified during the transaction, will invalidate the transaction. In the shown example, attribute Y is marked. It is worth mentioning here that, in practice, update operations to databases may include a multitude of attributes (e.g., in the Lightweight Directory Access Protocol (LDAP), an update may be performed on an entry that may hold even hundreds of attributes), but not all attributes may invalidate the transaction upon changes. It may thus be expedient to mark individual attributes only that are potentially subject to race conditions. This may generally be known from the application logic of the service/application executing the update.

In step 3, the instance of service A marks the message sent (NservC operation req) by the transaction Id in order to designate the message as belonging to the ongoing transaction. When the instance of service C receives this message, it may know that it needs to include the transaction Id in access requests to the UE session context database that are performed as part of the transaction. In step 4a, the instance of service C therefore includes the transaction Id in the write request for attribute X, which thus will be saved by the database as an attribute to be locked under the ongoing transaction. In step 4b, when the write request for attribute Y is received (to update attribute Y to a value different from A), the database may realize that a locked attribute (attribute Y has been locked in step 1) is about to be modified while the transaction is still ongoing and, therefore, the database rejects this request by sending a failure indication in step 6. In step 7, the instance of service A may close the transaction towards the database which, in turn, may release the control of the attributes under this transaction.

As has become apparent from the above, the present disclosure provides a technique for concurrency control of transactions in a system comprising a plurality of application instances accessing a database system. According to the presented technique, the database system may control the handling of race conditions, rather than an application instance accessing the database, and situations may therefore be avoided in which data is exclusively blocked by a single application instance throughout the completion of a whole transaction. The result of the presented race condition handling may be that data, such as a list of attributes, may effectively be protected until the transaction is finalized. As the presented technique may not allow modification of such data, no rollback mechanisms may be needed. Further, the presented technique may allow selecting a minimum set of attributes to be controlled by carefully selecting those attributes which may be subject to race conditions, wherein the selection may not be limited to only those attributes that are modified by the given transaction.

The technique presented herein may generally provide a fast and simple race condition handling method, which may particularly be suitable for environments in which complex multi-step transactions occur and where data contention is generally low, such as in 5G core networks, for example. As the technique presented herein may pose limited design constraints on the application logic of services performing the database updates, the technique may form a candidate for a standard solution in multi-vendor environments. The application instances themselves may not be required to take care of the race condition handling because this logic may essentially be placed in the database. As such, rollback functionality may generally be avoided by essentially serializing the transactions by the database functionality. Apart from write access requests, read access requests of the involved data may always be granted for parallel transactions during the execution of the ongoing transaction.

Further, requests within the ongoing transaction may generally be performed by different instances (of the same or different services) which have access to the same data, with the only requirement that a transaction identifier may be needed to be included into the access requests. The lock may thus not be exclusive to an application instance but rather to the transaction itself. In other words, every other application instance that shares the same data may perform writes, provided that it belongs to the same transaction. Any service instance within a set or pool of instances of the same service type may access the database under a relatively easy management of race conditions. This may even simplify aspects such as routing and load balancing in the system, for example.

It is believed that the advantages of the technique presented herein will be fully understood from the foregoing description, and it will be apparent that various changes may be made in the form, constructions and arrangement of the exemplary aspects thereof without departing from the scope of the invention or without sacrificing all of its advantageous effects. Because the technique presented herein can be varied in many ways, it will be recognized that the invention should be limited only by the scope of the claims that follow.

1. (canceled)

2. The computing unit of claim 33, wherein controlling acceptance of the access request includes one of:
accepting the access request when the access request belongs to the transaction, and
rejecting the access request when the access request does not belong to the transaction.

3. The computing unit of claim 33, wherein the first application instance is different from the second application instance.

4. (canceled)

5. The computing unit of claim 33, wherein the transaction start request includes a first transaction identifier uniquely identifying the transaction, wherein the access request includes a second transaction identifier indicating a transaction to which the access request belongs, and wherein checking whether the access request belongs to the transaction includes comparing the first transaction identifier and the second transaction identifier.

6. (canceled)

7. The computing unit of claim 33, wherein the access request is a write request and wherein read requests to the data from the plurality of application instances are accepted independently of whether the read requests belong to the transaction.

8. The computing unit of claim 33, wherein the transaction start request includes an indication of the data to be locked while the transaction is ongoing.

9. The computing unit of claim 33, wherein the data to be locked comprises data that is subject to read requests performed as part of the ongoing transaction.

10. The computing unit of claim 33, wherein the transaction start request corresponds to an initial read request performed as part of the transaction.

11. The computing unit of claim 33, wherein the data to be locked comprises one or more attributes of a record of the database system.

12. (canceled)

13. The computing unit of claim 33, further comprising:
receiving a transaction end request indicating an end of the transaction.

14. (canceled)

15. (canceled)

16. (canceled)

17. The computing unit of claim 34, wherein the transaction start request at least one of:
includes a transaction identifier uniquely identifying the transaction;
includes an indication of the data to be locked while the transaction is ongoing; and
corresponds to an initial read request performed as part of the transaction.

18. (canceled)

19. (canceled)

20. The computing unit of claim 34, wherein the data to be locked comprises one or more attributes of a record of the database system.

21. (canceled)

22. The computing unit of claim 34, wherein the first application instance is further comprising configured to:
trigger sending, to a second application instance, a message including the transaction identifier indicating to the second application instance that the message belongs to the ongoing transaction.

23. The computing unit of claim 34, wherein the first application instance is further configured to:
trigger sending, to the database system, a transaction end request indicating an end of the transaction.

24. (canceled)

25. (canceled)

26. The computing unit of claim 35, wherein the second application instance is further configured to:
receive, from the database system, an acceptance of the access request when the access request belongs to the ongoing transaction, and
receive, from the database system, a rejection of the access request when the access request does not belong to the ongoing transaction.

27. The computing unit of claim 35, wherein the second application instance is further configured to:
receive, from a first application instance, a message including a transaction identifier indicating that the message belongs to the ongoing transaction.

28. The computing unit of claim 35, wherein the access request includes a transaction identifier indicating a transaction to which the access request belongs.

29. The computing unit of claim 35, wherein the second application instance is further configured to:
trigger sending, to the database system, a transaction end request indicating an end of the transaction.

30.-32. (canceled)

33. A computing unit configured to execute a database system for concurrency control of transactions in a system comprising a plurality of application instances accessing the database system, the computing unit comprising:
at least one processor and at least one memory, the at least one memory containing instructions executable by the at least one processor such that the database system is configured to:
receive, from a first application instance of the plurality of application instances, a transaction start request indicating a start of a transaction to lock data stored in the database system against access requests not belonging to the transaction while the transaction is ongoing;
receive, from a second application instance of the plurality of application instances, an access request to at least a portion of the data while the transaction is ongoing; and
control acceptance of the access request based on checking whether the access request belongs to the transaction.

34. A computing unit configured to execute a first application instance for concurrency control of transactions in a system comprising a plurality of application instances accessing a database system, the computing unit comprising:
at least one processor and at least one memory, the at least one memory containing instructions executable by the at least one processor such that the first application instance is configured to:
trigger sending, to the database system, a transaction start request indicating a start of a transaction to cause the database system to lock data stored in the database system against access requests not belonging to the transaction while the transaction is ongoing.

35. A computing unit configured to execute a second application instance for concurrency control of transactions in a system comprising a plurality of application instances accessing a database system, the computing unit comprising:
at least one processor and at least one memory, the at least one memory containing instructions executable by the at least one processor such that the second application instance is configured to:
trigger sending, to the database system, an access request to at least a portion of data stored in the database system, the data being locked by the database system against access requests not belonging to an ongoing transaction.

36. (canceled)
